(19) United States
(12) Patent Application Publication
(10) Pub. No.: US 2004/0260551 A1
(43) Pub. Date: Dec. 23, 2004

(54) System and method for configuring voice readers using semantic analysis

(75) Inventors: Steven Edward Atkin, Austin, TX (US); Janani Janakiraman, Austin, TX (US); David Bruce Kumhyr, Austin, TX (US)

Correspondence Address: Joseph T. Van Leeuwen, P.O. Box 81641, Austin, TX, 78708-1641, US

(73) Assignee: International Business Machines Corporation, Armonk, NY

(21) Appl. No.: 10/464,881

(22) Filed: Jun. 19, 2003

(51) Int. Cl. G10L 13/08

(52) U.S. Cl. 704/260

(57) ABSTRACT

A system and method for using semantic analysis to configure a voice reader is presented. A text file includes a plurality of text blocks, such as paragraphs. Processing performs semantic analysis on each text block in order to match the text block's semantic content with a semantic identifier. Once processing matches a semantic identifier with the text block, processing retrieves voice attributes that correspond to the semantic identifier (i.e. pitch value, loudness value, and pace value) and provides the voice attributes to a voice reader. The voice reader uses the text block to produce a synthesized voice signal with properties that correspond to the voice attributes. The text block may include semantic tags whereby processing performs latent semantic indexing on the semantic tags in order to match semantic identifiers to the semantic tags.

### BACKGROUND OF THE INVENTION

1. Technical Field

The present invention relates in general to a system and method for using semantic analysis to configure a voice reader. More particularly, the present invention relates to a system and method for dynamically selecting voice attributes that correspond to a text block's semantic content and using the voice attributes to convert the text block into synthesized speech.

2. Description of the Related Art

Voice readers are used to convert a text file into synthesized speech. The text file may be received from an external source, such as a web page, or the text file may be received form a local source, such as a compact disc. For example, a user with impaired vision may use a voice reader which receives a web page from a server through a computer network (i.e. Internet) which converts the web page text into synthesized speech for the user to hear. In another example, a young child may use a voice reader that retrieves a children's book text file from a compact disc and converts the children's book text file into synthesized speech for the child to hear.

A challenge found with voice readers, however, is that the speech in which a voice reader generates is not dynamically configurable. For example, a voice reader may be pre-configured to read text using a female voice at slow speed. In this example, the pre-configured voice is suitable while converting children's book text for a child to hear but may not be suitable while converting a financial article for an adult to hear.

Furthermore, voice readers are not configurable to convert particular sections of a text file based upon a user's interest. For example, a user may be interested in “summary” sections included in a particular technical document. In this example, the voice reader converts the text file using pre-configured voice attributes for each section and generates synthesized speech for each section, regardless of the section's content.

What is needed, therefore, is a system and method for dynamically configuring voice reader attributes such that the voice reader attributes correspond with the semantic content of the text that the voice reader is converting.

### SUMMARY

It has been discovered that the aforementioned challenges are resolved by performing semantic analysis on a text block and using voice attributes that correspond to the semantic analysis result for dynamically configuring a voice reader. A client receives a text file and segments the text file into a plurality of text blocks. In one embodiment, the client receives the text file from a web page server through a computer network, such as the Internet. In another embodiment, the client receives the text file from a storage device, such as a compact disc. The client sends a text block to a semantic analyzer

The semantic analyzer performs semantic analysis on the text block by matching semantic identifiers located in a look-up table with the text block using standard semantic analysis techniques. For example, the semantic analyzer may use semantic analysis techniques such as symbolic machine learning, graph-based clustering and classification, statistics-based multivariate analyses, artificial neural network-based computing, or evolution-based programming. The semantic analyzer matches a semantic identifier with the text block based upon the semantic analysis results, and retrieves voice attributes corresponding to the matched semantic identifier from the look-up table.

The semantic identifier may be a subject matter semantic identifier or a user interest semantic identifier. A subject matter semantic identifier corresponds to particular subject matter, such as a children's book or a financial article. A user interest semantic identifier corresponds to particular areas of interest, such as a summary, detail, or section headings of a text file. For example, the semantic analyzer identifies that a text block is a paragraph corresponding to financial information and associates a “Business Journal” semantic identifier with the text block. In this example, the semantic analyzer retrieves voice attributes corresponding to the “Business Journal” semantic identifier from the look-up table.

The semantic analyzer provides the voice attributes to a voice reader. The voice attributes include attributes such as a pitch value, a loudness value, and a pace value. In one embodiment, the voice attributes are provided to the voice reader through an Application Program Interface (API). The voice reader inputs the voice attributes into a voice synthesizer whereby the voice synthesizer converts the text block into synthesized speech for a user to hear.

In one embodiment, the text file includes semantic tags that correspond to the semantic content of particular text blocks. In this embodiment, the semantic analyzer performs latent semantic indexing on the semantic tags in order to match a semantic identifier with a semantic tag. Latent semantic indexing organizes text objects into a semantic structure by using implicit higher-order approaches to associate text objects, such as singular-value decomposition. For example, a server may have previously analyzed a text block and the server inserted semantic tags into the text block that correspond to the semantic content of the text block.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a diagram showing a client receiving a web page from a server and producing a synthesized voice signal with attributes that correspond to the semantic content of the web page;

FIG. 2 is a diagram showing a client receiving a web page that includes semantic tags from a server and producing a synthesized voiced signal with attributes that correspond to the semantic content of the semantic tags;

FIG. 3 is diagram showing a computer system converting a text file into a synthesized voice signal with attributes that correspond to the text file's semantic content;

FIG. 4A is detail diagram showing a voice reader receiving voice attributes from an embedded semantic analyzer that correspond to a text file's semantic properties;

FIG. 4B is detail diagram showing a voice reader receiving voice attributes from an external semantic analyzer that correspond to a text file's semantic properties;

FIG. 5A is look-up table showing voice attributes corresponding to subject matter semantic identifiers;

FIG. 5B is look-up table showing voice attributes corresponding to user interest semantic identifiers;

FIG. 6 is a user configuration window showing semantic identifiers and corresponding voice attributes;

FIG. 7 is a flowchart showing steps taken in translating a plurality of text blocks to a synthesized voice signal;

FIG. 8 is a flowchart showing steps taken in identifying a semantic identifier that corresponds to a text block or a semantic tag by using semantic analysis; and

FIG. 9 is a block diagram of an information handling system capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

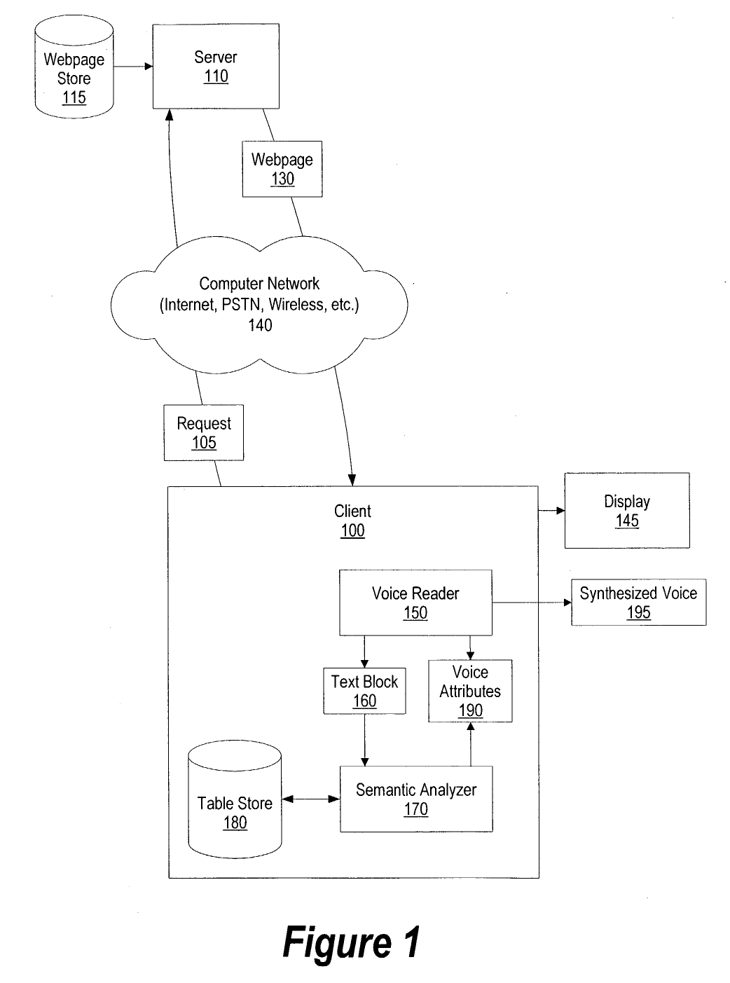

FIG. 1 is a diagram showing a client receiving a web page from a server and producing a synthesized voice signal with attributes that correspond to the semantic content of the web page. Client 100 sends request 105 to server 110 through computer network 140, such as the Internet. Request 105 includes an identifier for a particular web page (i.e. URL) that server 110 supports. For example, request 105 may correspond to a financial article and server 110 may be a server that supports “WallStreetJournal.com”. Server 110 receives request 105 and retrieves a web page from web page store 115 that corresponds to the request. Server 110 sends web page 130 to client 100 through computer network 140.

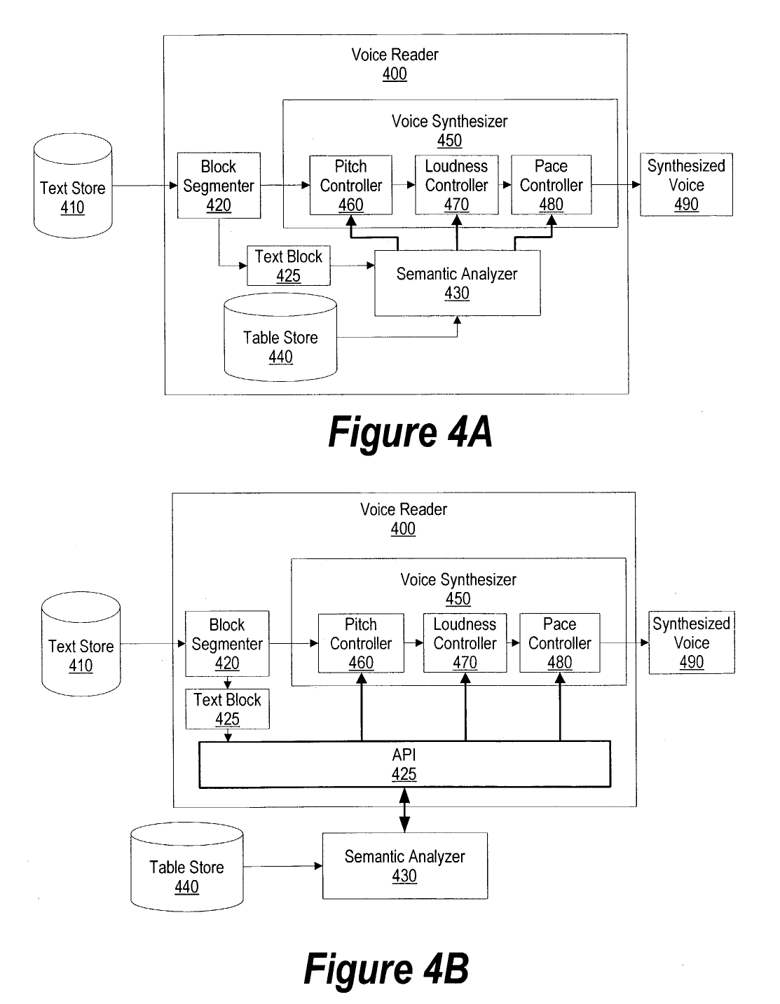

Client 100 receives web page 130 and displays the web page on display 145. Using the example described above, client 100 displays the financial article on display 145 for a user to read. Client 100 includes voice reader 150 which is able to convert text into a synthesized voice signal, such as synthesized voice 195 (see FIGS. 4A, 4B, and corresponding text for further details regarding voice reader properties). Voice reader 150 sends text block 160 to semantic analyzer 170. Text block 160 is a section of text that is included in web page 130, such as a paragraph. Semantic analyzer 170 performs semantic analysis on text block 160 by matching semantic identifiers located in table store 180 with the text block using standard semantic analysis techniques. For example, semantic analyzer 170 may use semantic analysis techniques such as symbolic machine learning, graph-based clustering and classification, statistics-based multivariate analyses, artificial neural network-based computing, or evolution-based programming.

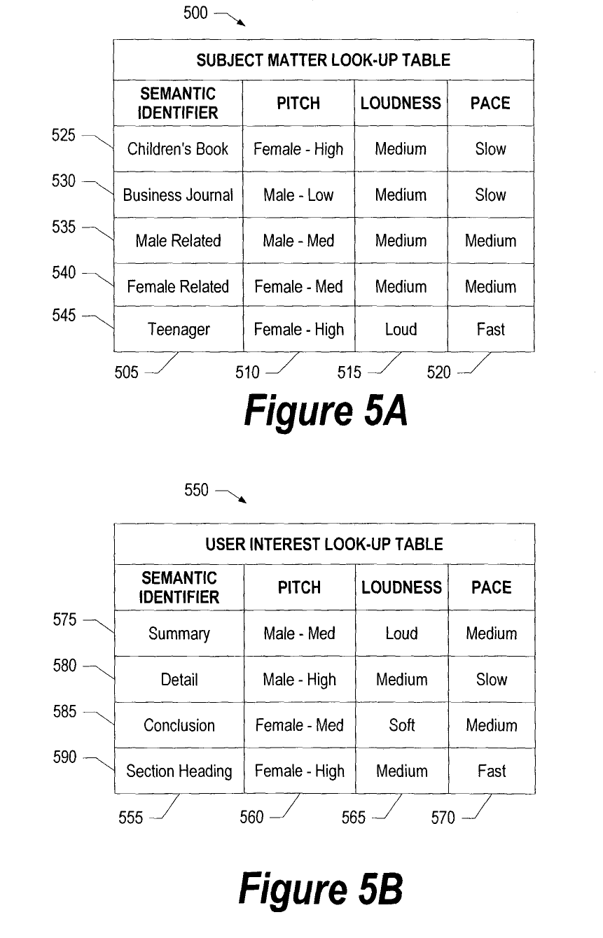

Semantic analyzer 170 matches a semantic identifier with the text block based upon the semantic analysis, and retrieves voice attributes corresponding to the matched semantic identifier from a look-up table located in table store 180. Using the example described above, semantic analyzer 170 identifies that text block 160 is a paragraph corresponding to financial information and selects a “Business Journal” semantic identifier to correspond with text block 160. In this example, semantic analyzer 170 retrieves voice attributes corresponding to the “Business Journal” semantic identifier for a look-up table (see FIGS. 5A, 5B, and corresponding text for further details regarding look-up tables) Table store 180 may be stored on a nonvolatile storage area, such as a computer hard drive.

Semantic analyzer 170 provides the retrieved voice attributes (e.g. voice attributes 190) to voice reader 150. Voice attributes 190 include attributes such as a pitch value, a loudness value, and a pace value. In one embodiment, voice attributes 190 are provided to voice reader 150 through an Application Program Interface (API) (see FIG. 4B and corresponding text for further details regarding API's). Voice reader 150 inputs voice attributes 190 into a voice synthesizer. The voice synthesizer converts the text block into synthesized voice 195 for a user to hear.

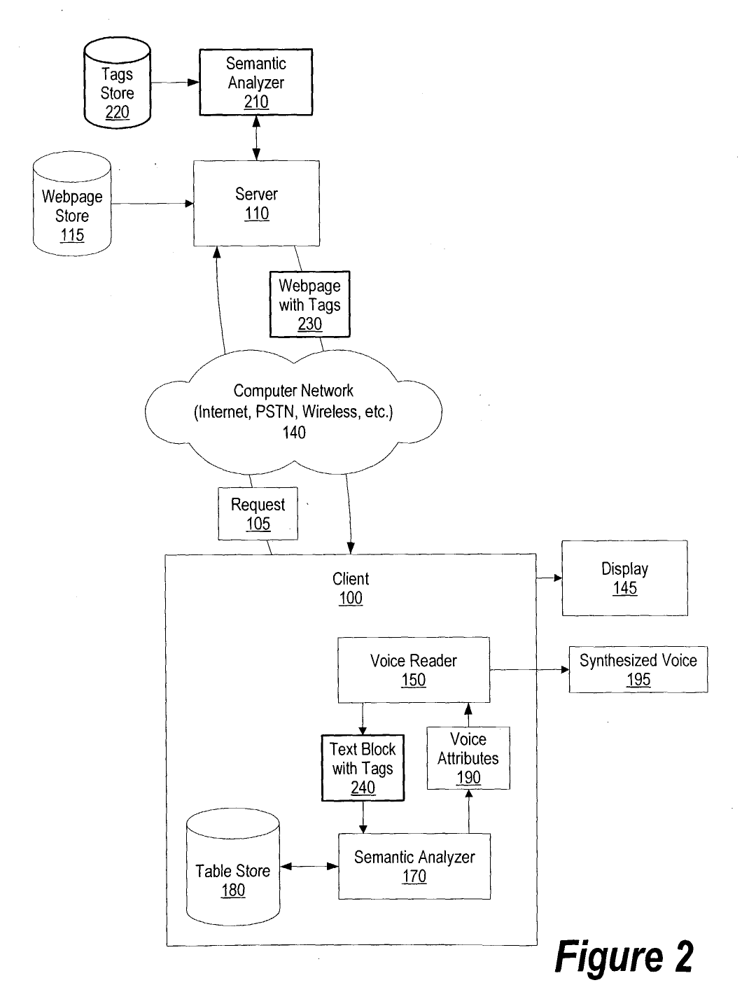

FIG. 2 is a diagram showing a client receiving a web page that includes semantic tags from a server and producing a synthesized voiced signal with attributes that correspond to the semantic content of the semantic tags. FIG. 2 is similar to FIG. 1 with the exception that FIG. 2's server 110 uses semantic analyzer 210 to perform semantic analysis on a requested web page. Semantic analyzer 210 uses standard semantic analysis techniques and matches semantic tags located in tag store 220 with particular text blocks (i.e. paragraphs). Tags store 220 may be stored on a nonvolatile storage area, such as a computer hard drive.

Semantic analyzer 210 provides the matched tags to server 110 which inserts the tags into the requested web page. Server then sends web page with tags 230 to client 100. Client 100 receives web page 230 whereby voice reader 150 identifies a first text block and sends text block with tags 240 to semantic analyzer 170. Semantic analyzer 170 performs latent semantic indexing on the tag content, and associates a semantic identifier with the tag based upon the semantic analysis. Latent semantic indexing organizes text objects into a semantic structure by using implicit higher-order approaches to associate text objects, such as singular-value decomposition. For example, a tag may be “cash flow” and semantic analyzer 170 may associate a semantic identifier “financial” with the semantic tag.

Semantic analyzer 170 retrieves voice attributes corresponding to the associated semantic identifier from table store 180 and sends voice attributes 190 to voice reader 150. Voice reader 150 inputs voice attributes 190 into a voice synthesizer. The voice synthesizer converts the text block into synthesized voice 195 for a user to hear.

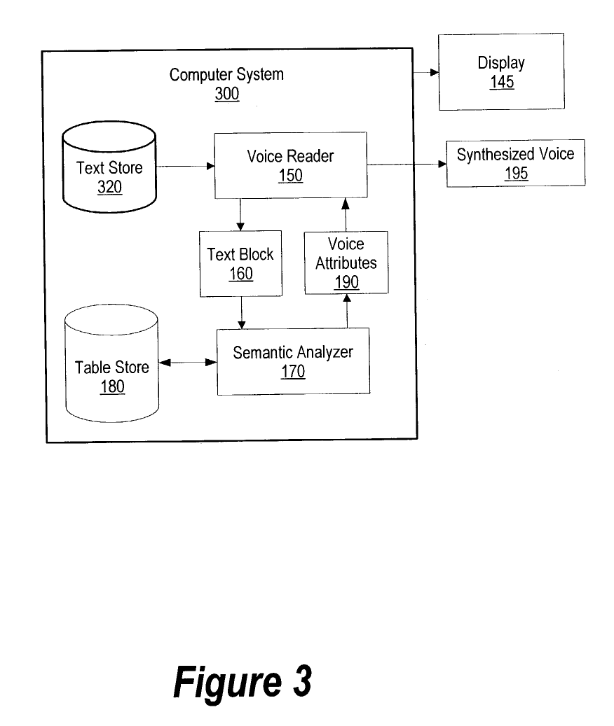

FIG. 3 is diagram showing a computer system converting a text file into a synthesized voice signal with attributes that correspond to the text file's semantic content. FIG. 3 is similar to FIG. 1 with the exception that computer system 300 does not receive a text file over a computer network, but rather retrieves the text file from a local storage area. For example, a user may insert a compact disc into computer system 300's disk drive which includes a text file corresponding to a children's book and the text file is loaded into computer system 300's local storage area, such as text store 320. Text store 320 may be stored on a nonvolatile storage area, such as a computer hard drive.

Voice reader 150 retrieves a text file from text store 320 and sends a text block (e.g. text block 160) to semantic analyzer 170 for processing. As one skilled in the art can appreciate, the text file may include semantic tags whereby semantic analyzer performs latent semantic indexing on the semantic tags (see FIG. 2 and corresponding text for further details semantic tag analysis).

FIG. 4A is detail diagram showing a voice reader receiving voice attributes from an embedded semantic analyzer that correspond to a text file's semantic properties. Voice reader 400 retrieves a text file from text file 410 and segments the text file into text blocks using block segmenter 420. For example, block segmenter 420 may search for paragraph breaks and create a text block for each paragraph. Block segmenter 420 sends text block 425 to semantic analyzer 430 for processing.

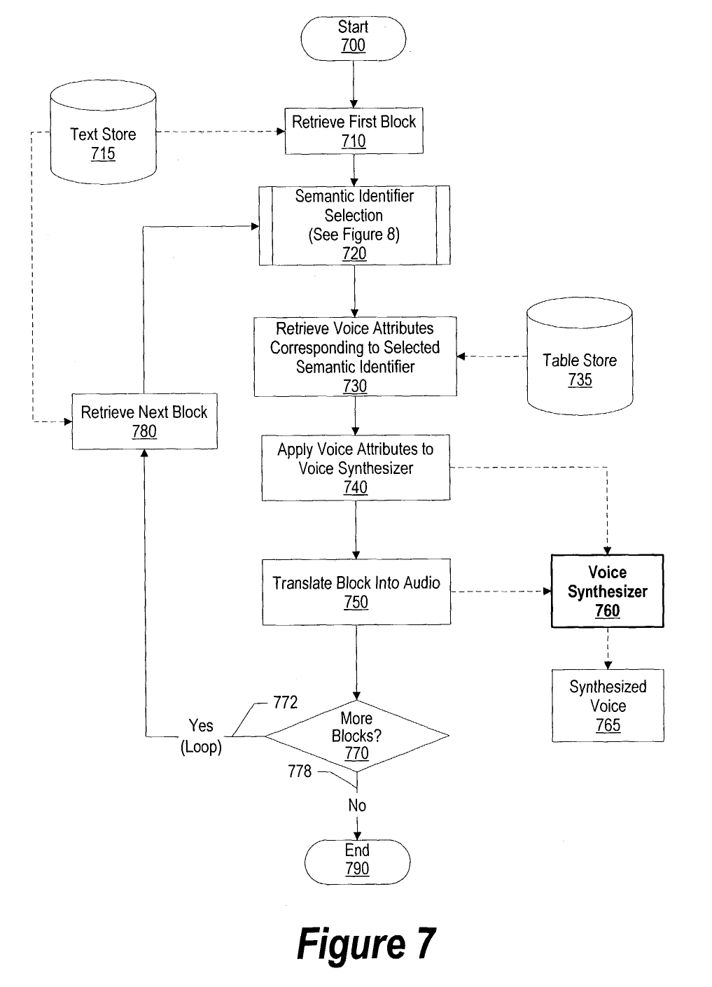

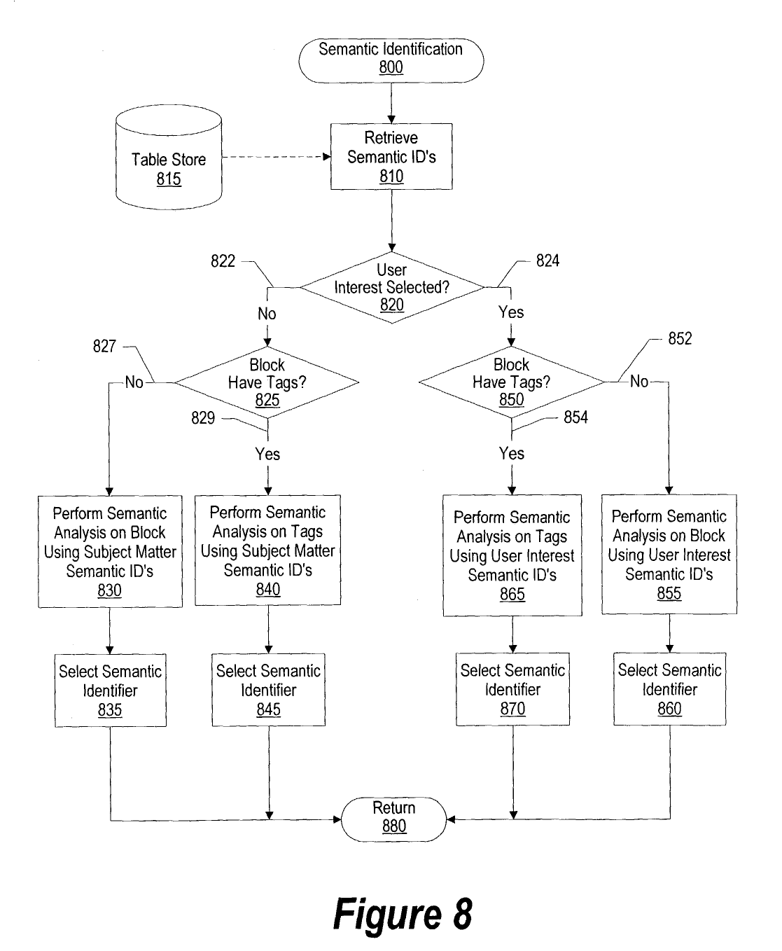

Semantic analyzer 430 performs semantic analysis on text block 425 and matches a semantic identifier to text block 425 based upon the semantic analysis (see FIGS. 7, 8, and corresponding text for further details regarding semantic identifier selection). Semantic analyzer 430 retrieves voice attributes from table store 440 that correspond to the matched semantic identifier. The voice attributes include a pitch value, a loudness value, and a pace value. Semantic analyzer 430 provides the voice attributes to voice synthesizer 450. In turn, voice synthesizer 450 inputs the voice attributes into pitch controller 460, loudness controller 470, and pace controller 480. Pitch controller 460 produces a synthesized pitch of the synthesized voice (i.e. male voice) that corresponds to a pitch value voice attribute. Loudness controller 470 controls the loudness of the synthesized voice (i.e. soft) that corresponds to a loudness value voice attribute. Pace controller 480 controls the pace of a synthesized voice (i.e. fast) that corresponds to a pace value voice attribute.

FIG. 4B is detail diagram showing a voice reader receiving voice attributes from an external semantic analyzer that correspond to a text file's semantic properties. FIG. 4B is similar to FIG. 4A with the exception that semantic analyzer 430 is external to voice reader 400. Semantic analyzer 430 receives text blocks from block segmenter 420 through API 425.

Semantic analyzer 430 performs semantic analysis on the received text block and retrieves voice attributes from voice attributes store 440 corresponding to the results of the semantic analysis. In turn, semantic analyzer 430 provides the voice attributes (i.e. pitch value, loudness value, and pace value) to voice reader 450 through API 425. Voice synthesizer 450 synthesizes the text block and creates synthesized voice 490 using the received voice attributes.

FIG. 5A is look-up table showing voice attributes corresponding to subject matter semantic identifiers. Subject matter semantic identifiers are semantic identifiers that correspond to a particular subject matter, such as a children's book or a financial news report. A semantic analyzer associates a semantic identifier to a particular text block. In turn, the semantic analyzer retrieves voice attributes that correspond to the associated semantic identifier and provides the voice attributes to a voice reader which converts the text block to synthesized voice. The voice attributes specify voice characteristics for the voice reader to use during a text block conversion, such as a pitch value, a loudness value, and a pace value. For example, a user may wish to have a children's book read to his child in a female's voice at a slow speed so the children's book is appealing to the child (see FIGS. 4A, 4B, and corresponding text for further details regarding voice synthesizers).

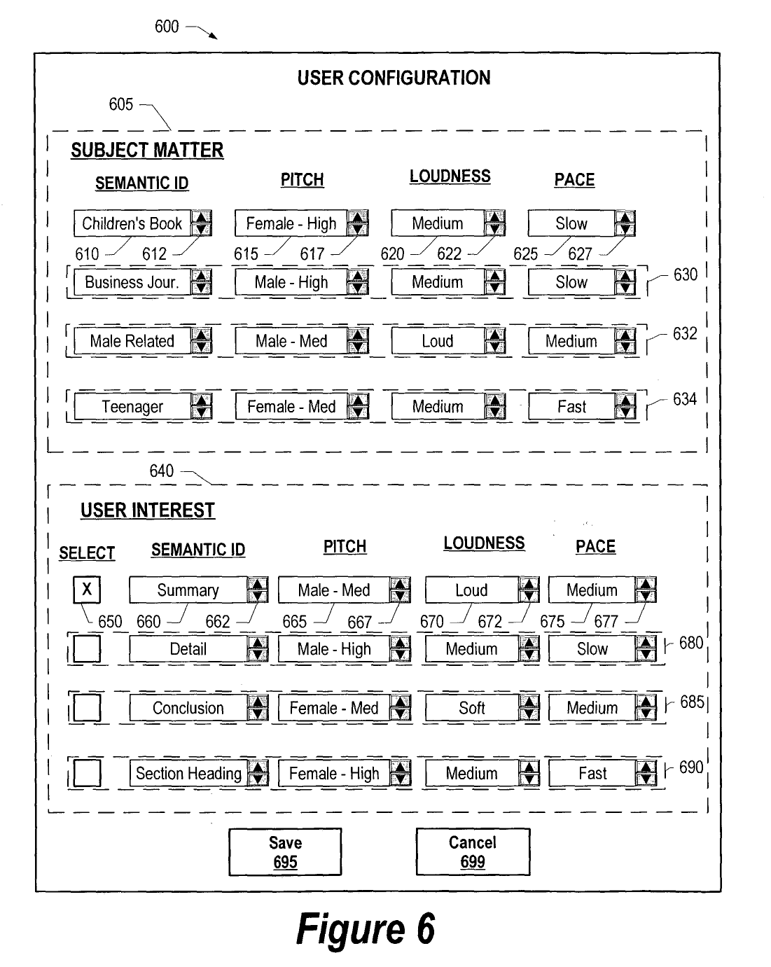

Table 500 includes columns 505, 510, 515, and 520. Column 505 includes a list of subject matter semantic identifiers. These semantic identifiers may be pre-selected or a user may select particular semantic identifiers for converting text blocks into synthesized speech. For example, a subject matter look-up table may include a “Children's Book” and a “Business Journal” semantic identifier as default semantic identifiers and a user may select other semantic identifiers to include in the subject matter look-up table (see FIG. 6 and corresponding text for further details regarding user configuration window properties).

Column 510 includes a list of voice attribute “Pitch” values that correspond to semantic identifiers shown in column 505. Pitch values may be values such as female-high, female-medium, female-low, male-high, male-medium, male-low. A pitch value instructs a voice reader as to which voice type to use when converting a text block to synthesized speech. For example, row 525 includes a “Children's Book” semantic identifier and its corresponding pitch value is “Female-High”. In this example, the female-high pitch value instructs a voice reader to use a high pitch female voice when converting text blocks that are identified as “Children's Book” through semantic analysis.

Column 515 includes a list of voice attribute “Loudness” values that correspond to semantic identifiers shown in column 505. Loudness values may be values such as loud, medium, or soft. A loudness value instructs a voice reader as to how loud to generate speech when converting a text block. Using the example described above, row 525 includes a “Medium” loudness value which instructs a voice reader to generate speech at a medium volume level when converting text blocks that are identified as “Children's Book” using semantic analysis.

Column 520 includes a list of voice attribute “Pace” values that correspond to semantic identifiers shown in column 505. Pace values may be values such as “Slow”, “Medium”, or “Fast”. A pace value instructs a voice reader as to how fast to generate speech when converting a text block. Using the example described above, row 525 includes a “Slow” pace value which instructs a voice reader to generate speech at a slow pace when converting text blocks that are identified as “Children's Book”.

Row 530 includes a “Business Journal” semantic identifier with corresponding voice attributes “Male-Low”, “Medium”, and “Slow”. When a semantic analyzer associates a text block with the “Business Journal” semantic identifier, such as a financial statement, the semantic analyzer provides corresponding voice attributes to a voice reader. In turn, the voice reader converts the text block to speech using a low pitch male voice at medium volume and slow pace.

Row 535 includes a “Male-Related” semantic identifier with corresponding voice attributes “Male-Medium”, “Medium”, and “Medium”. When a semantic analyzer associates a text block with the “Male-Related” semantic identifier, such as men's fitness information, the semantic analyzer provides corresponding voice attributes to a voice reader. In turn, the voice reader converts the text block to speech using a medium pitch male voice at medium volume and medium pace.

Row 540 includes a “Female-Related” semantic identifier with corresponding voice attributes “Female-Medium”, “Medium”, and “Medium”. When a semantic analyzer associates a text block with the “Female-Related” semantic identifier, such as women's fitness information, the semantic analyzer provides corresponding voice attributes to a voice reader. In turn, the voice reader converts the text block to speech using a medium pitch female voice at medium volume and medium pace.

Row 545 includes a “Teenager” semantic identifier with corresponding voice attributes “Female-High”, “Loud”, and “Fast”. When a semantic analyzer associates a text block with the “Teenager” semantic identifier, such as lyrics to a pop song, the semantic analyzer provides corresponding voice attributes to a voice reader. In turn, the voice reader converts the text block to speech using a high pitch female voice at loud volume and fast pace.

A user may configure semantic identifier types other than subject matter semantic identifiers, such as user interest semantic identifiers, in order to customize a voice reader's text to speech conversion process (see FIG. 5B and corresponding text for further details regarding user interest semantic identifiers).

FIG. 5B is look-up table showing voice attributes corresponding to user interest semantic identifiers. User interest semantic identifiers are semantic identifiers that that a user configures based upon the user's interest. For example, user interest semantic identifiers may include “Summary”, “Detail”, and “Section Heading”. A semantic analyzer associates a semantic identifier to a particular text block. In turn, the semantic analyzer retrieves voice attributes that correspond to the associated semantic identifier and provides the voice attributes to a voice reader to convert the text block to speech. The voice attributes specify voice characteristics for the voice reader to use during a text block conversion, such as a pitch value, a loudness value, and a pace value. For example, a user may be interested in listening to a summary of a particular document. In this example, the user configures a “Summary” semantic identifier using a configuration window (see FIG. 6 and corresponding text for further details regarding user configuration window properties).

Table 550 includes columns 555, 560, 565, and 570. Column 555 includes a list of user interest semantic identifiers. Columns 560, 565, and 570 include a list of voice attribute types that are the same as columns 510, 515, and 520 as shown in FIG. 5A, respectively.

Row 575 includes a “Summary” semantic identifier with corresponding voice attributes “Male-Medium”, “Loud”, and “Medium”. When a semantic analyzer associates a text block with the “Summary” semantic identifier, such as an overview of a technical document, the semantic analyzer provides corresponding voice attributes to a voice reader. In turn, the voice reader converts the text block to speech using a medium pitch male voice at loud volume and medium pace.

Row 580 includes a “Detail” semantic identifier with corresponding voice attributes “Male-High”, “Medium”, and “Slow”. When a semantic analyzer associates a text block with the “Detail” semantic identifier, such as a specification in a technical document, the semantic analyzer provides corresponding voice attributes to a voice reader. In turn, the voice reader converts the text block to speech using a high pitch male voice at medium volume and slow pace.

Row 585 includes a “Conclusion” semantic identifier with corresponding voice attributes “Female-Medium”, “Soft”, and “Medium”. When a semantic analyzer associates a text block with the “Conclusion” semantic identifier, such as the results of an experiment, the semantic analyzer provides corresponding voice attributes to a voice reader. In turn, the voice reader converts the text block to speech using a medium pitch female voice at soft volume and medium pace.

Row 590 includes a “Section Heading” semantic identifier with corresponding voice attributes “Female-High”, “Medium”, and “Fast”. When a semantic analyzer associates a text block with the “Section Heading” semantic identifier, such as a sub-title of a section, the semantic analyzer provides corresponding voice attributes to a voice reader. In turn, the voice reader converts the text block to speech using a high pitch female voice at medium volume and fast pace.

FIG. 6 is a user configuration window showing semantic identifiers and corresponding voice attributes. A user uses window 600 to customize voice attributes corresponding to particular semantic identifiers. Window 600 includes area 605 which includes subject matter semantic identifiers, and area 640 which includes user interest semantic identifiers.

A user selects a particular subject matter semantic identifier by using arrows 612 to scroll through a list of subject matter semantic identifiers until the user's desired subject matter semantic identifier is displayed in text box 610. For example, a list of subject matter semantic identifiers may be “Children's Book”, “Business Journal”, and “Teenager Related”. The example shown in FIG. 6 shows that the user selected “Children's Book”.

Once the user selects a subject matter semantic identifier, the user configures a pitch value, a loudness value, and a pace value to correspond with the subject matter semantic identifier. The user selects a particular pitch value by using arrows 617 to scroll through a list of pitch values until the user's desired pitch value is displayed in text box 615. For example, a list of pitch values may be “female-high”, “female-medium”, “female-low”, “male-high”, “male-medium”, “male-low”. The example shown in FIG. 6 shows that the user selected “female-high” as a pitch value to correspond with the “Children's Book” semantic identifier.

The user selects a particular loudness value by using arrows 622 to scroll through a list of loudness values until the user's desired loudness value is displayed in text box 620. For example, a list of loudness values may be “Loud”, “medium”, and “soft”. The example shown in FIG. 6 shows that the user selected “medium” as a loudness value to correspond with the “Children's Book” semantic identifier.

The user selects a particular pace value by using arrows 627 to scroll through a list of pace values until the user's desired pace value is displayed in text box 625. For example, a list of pace values may be “Fast”, “Medium”, and “Slow”. The example shown in FIG. 6 shows that the user selected “slow” as a pace value to correspond with the “Children's Book” semantic identifier.

Rows 630 through 634 are other rows that a user may use to select a subject matter semantic identifier and configure corresponding voice attributes. As one skilled in the art can appreciate, more or less subject matter semantic identifier choices may be available than that which is shown in FIG. 6.

Area 640 includes user interest semantic identifiers that a user selects and configures corresponding voice attributes. A user selects a particular user interest semantic identifier by using arrows 662 to scroll through a list of user interest semantic identifiers until the user's desired user interest semantic identifier is displayed in text box 660. For example, a list of user interest semantic identifier's may be “Summary”, “Detail”, and “Section Heading”. The example shown in FIG. 6 shows that the user selected a “Summary” user interest semantic identifier.

Once the user selects a user interest semantic identifier, the user configures a pitch value, a loudness value, and a pace value to correspond with the user interest semantic identifier. The user selects a particular pitch value by using arrows 667 to scroll through a list of pitch values until the user's desired pitch value is displayed in text box 665. In addition, the user selects a particular loudness value by using arrows 672 to scroll through a list of loudness values until the user's desired loudness value is displayed in text box 670. Furthermore, the user selects a particular pace value by using arrows 677 to scroll through a list of pace values until the user's desired pace value is displayed in text box 675. Finally, user selects box 650 in order to inform processing that the user wishes to hear text blocks corresponding to a particular semantic identifier.

Rows 680 through 690 are other rows that a user may use to select a user interest semantic identifier and configure corresponding voice attributes. As one skilled in the art can appreciate, more or less user interest semantic identifier choices may be available than that which is shown in FIG. 6.

When the user is finished configuring semantic identifiers and corresponding voice attributes, the user selects command button 695 to save changes and exit window 600. If the user does not wish to save changes, the user selects command button 699 to exit window 600 without saving changes.

FIG. 7 is a flowchart showing steps taken in translating a plurality of text blocks to a synthesized voice signal. Processing commences at 700, whereupon processing retrieves a first text block from text store 715 at step 710. The first text block is a segment of a text file, such as a paragraph. In one embodiment, the text file includes a web page that was previously received from a server through a computer network, such as the Internet. In another embodiment, the text file includes a text document that was retrieved from a local input device, such as a compact disc reader. Input store 715 may be stored on a nonvolatile storage area, such as a computer hard drive.

Processing performs semantic analysis on the text block in order to match a semantic identifier to the text block (pre-defined process block 720, see FIG. 8 and corresponding text for further details). As one skilled in the art can appreciate, standard semantic analysis techniques, such as symbolic machine learning, graph-based clustering and classification, statistics-based multivariate analyses, artificial neural network-based computing, or evolution-based programming may be used to perform semantic analysis on a text block. The semantic identifier corresponds to particular voice attributes (i.e. loudness, pitch, and pace) that a user configures for a particular semantic identifier (see FIG. 6 and corresponding text for further details regarding user configuration).

Processing retrieves the voice attributes that correspond to the identified semantic identifier from table store 735 (step 730). Table store 735 may be stored on a nonvolatile storage area, such as a computer hard drive. Processing provides the voice attributes to voice synthesizer 760 at step 740 using a direct connection or using an API (see FIGS. 4A, 4B and corresponding text for further details regarding voice synthesizer approaches). Voice synthesizer 760 is a device or a software subroutine that converts text to synthesized speech using Text to Speech Synthesis (TTS). Processing translates the text block to synthesized voice 765 (e.g. speech) at step 750 using voice synthesizer 760.

A determination is made as to whether there are more text blocks to process (decision 770). If there are more blocks to process, decision 770 branches to “Yes” branch 772 which loops back to retrieve (step 780) and process the next text block. This looping continues until there are no more text blocks to process, at which point decision 770 branches to “No” branch 778 whereupon processing ends at 790.

FIG. 8 is a flowchart showing steps taken in identifying a semantic identifier that corresponds to a text block or a semantic tag by using semantic analysis. Processing commences at 800, whereupon processing retrieves semantic identifiers from table store 815 (step 810). The semantic identifiers include subject matter semantic identifiers and may include one or more user interest semantic identifiers corresponding to a user's request to translate particular text blocks into synthesized speech. For example, a user may wish to hear summary information included in a text file in a slow, male voice and wish to hear detail information included in the text file in a fast, female voice (see FIG. 6 and corresponding text for further details regarding user configurations). Table store 815 may be stored on a nonvolatile storage area, such as a computer hard drive.

A determination is made as to whether the semantic identifiers include one or more user interest semantic identifiers (decision 820). If the semantic identifiers include one or more user interest semantic identifiers, decision 820 branches to “Yes” branch 824 whereupon a determination is made as to whether the text block includes semantic tags (decision 850). For example, a server may have previously analyzed the text block whereby the server inserted semantic tags into the text block that correspond to the semantic content of the text block (see FIG. 2 and corresponding text for further details regarding semantic tag insertion).

If the text block includes semantic tags, decision 850 branches to “Yes” branch 854 whereupon processing performs latent semantic indexing on the semantic tags using the user interest semantic identifiers. Latent semantic indexing organizes text objects into a semantic structure by using implicit higher-order approaches to associate text objects, such as singular-value decomposition. For example, the semantic tag may be “Abstract” and the user interest semantic identifiers are “Summary”, “Detail”, and “Section Headings”. Processing selects a semantic identifier at step 870 based upon the semantic analysis performed at step 865. Using the example described above, processing selects the semantic identifier “Summary” since “Summary” is the closest semantic identifier to “Abstract”.

On the other hand, if the text block does not include semantic tags, decision 850 branches to “No” branch 852 whereupon processing performs semantic analysis on the text block using the user interest semantic identifiers (step 855). For example, the text block may include overview information for a particular document, such as a technical document, and the user interest semantic identifiers include “Summary”, “Detail”, and “Section Headings”. Processing selects a semantic identifier based upon the semantic analysis performed at step 855 (step 860). Using the example described above, processing selects the semantic identifier “Summary” since “Summary” is the closest match to an “overview”.

If the semantic identifiers do not include a user interest semantic identifier, decision 820 branches to “No” branch 822 whereupon a determination is made as to whether the text block includes semantic tags (decision 825). For example, a server may have previously analyzed the text block and the server inserted semantic tags into the text block that correspond to the semantic content of the text blocks (see FIG. 2 and corresponding text for further details regarding semantic tag insertion). If the text block includes semantic tags, decision 825 branches to “Yes” branch 829 whereupon processing performs latent semantic indexing on the semantic tags using subject matter semantic identifiers (step 840). For example, the semantic tag may be “Financial” and the subject matter semantic identifiers include “Children's Book”, “Business Journal”, and “Teenager Related”. Processing selects a semantic identifier at step 845 based upon the semantic analysis performed at step 840. Using the example described above, processing selects the semantic identifier “Business Journal” since “Business Journal” is the closest match to the “Financial” tag.

On the other hand, if the text block does not include semantic tags, decision 825 branches to “No” branch 827 whereupon processing performs semantic analysis on the text block using the subject matter semantic identifiers. For example, the text block may include a financial statement for a particular company and the subject matter semantic identifiers are “Children's Book”, “Business Journal”, and “Teen Related”. Processing selects a semantic identifier based upon the semantic analysis performed at step 830 (step 835). Using the example described above, processing selects the semantic identifier “Business Journal” since “Business Journal” is the closest match to financial statement information. Processing returns at 880.

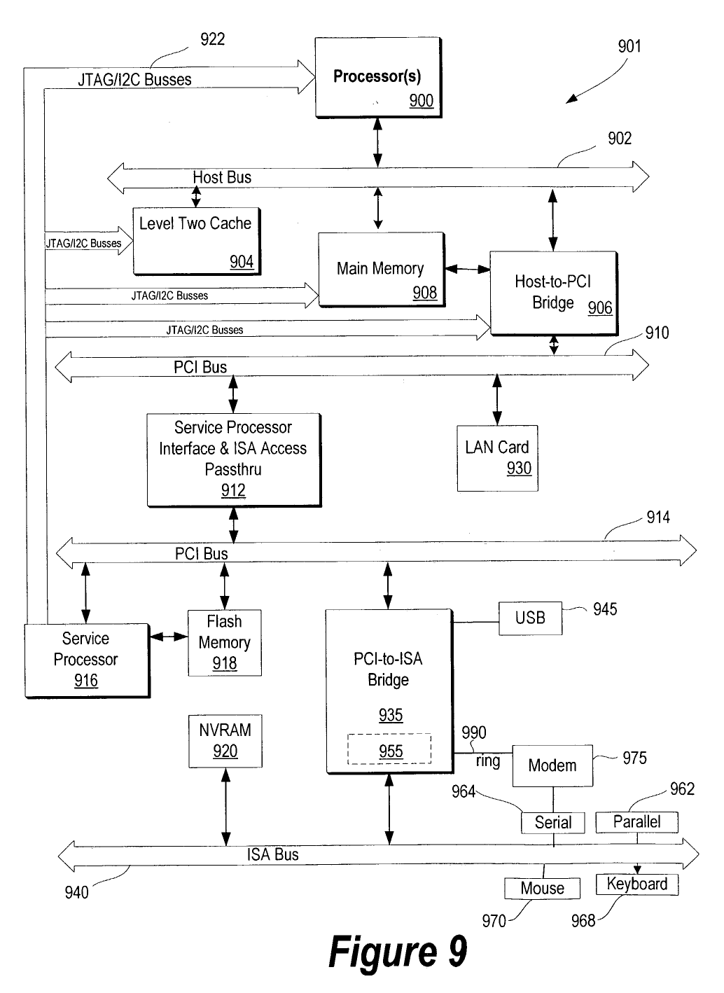

FIG. 9 illustrates information handling system 901 which is a simplified example of a computer system capable of performing the computing operations described herein. Computer system 901 includes processor 900 which is coupled to host bus 902. A level two (L2) cache memory 904 is also coupled to host bus 902. Host-to-PCI bridge 906 is coupled to main memory 908, includes cache memory and main memory control functions, and provides bus control to handle transfers among PCI bus 910, processor 900, L2 cache 904, main memory 908, and host bus 902. Main memory 908 is coupled to Host-to-PCI bridge 906 as well as host bus 902. Devices used solely by host processor(s) 900, such as LAN card 930, are coupled to PCI bus 910. Service Processor Interface and ISA Access Pass-through 912 provides an interface between PCI bus 910 and PCI bus 914. In this manner, PCI bus 914 is insulated from PCI bus 910. Devices, such as flash memory 918, are coupled to PCI bus 914. In one implementation, flash memory 918 includes BIOS code that incorporates the necessary processor executable code for a variety of low-level system functions and system boot functions.

PCI bus 914 provides an interface for a variety of devices that are shared by host processor(s) 900 and Service Processor 916 including, for example, flash memory 918. PCT-to-ISA bridge 935 provides bus control to handle transfers between PCI bus 914 and ISA bus 940, universal serial bus (USB) functionality 945, power management functionality 955, and can include other functional elements not shown, such as a real-time clock (RTC), DMA control, interrupt support, and system management bus support. Nonvolatile RAM 920 is attached to ISA Bus 940. Service Processor 916 includes JTAG and I2C busses 922 for communication with processor(s) 900 during initialization steps. JTAG/I2C busses 922 are also coupled to L2 cache 904, Host-to-PCI bridge 906, and main memory 908 providing a communications path between the processor, the Service Processor, the L2 cache, the Host-to-PCI bridge, and the main memory. Service Processor 916 also has access to system power resources for powering down information handling device 901.

Peripheral devices and input/output (I/O) devices can be attached to various interfaces (e.g., parallel interface 962, serial interface 964, keyboard interface 968, and mouse interface 970 coupled to ISA bus 940. Alternatively, many I/O devices can be accommodated by a super I/O controller (not shown) attached to ISA bus 940.

In order to attach computer system 901 to another computer system to copy files over a network, LAN card 930 is coupled to PCI bus 910. Similarly, to connect computer system 901 to an ISP to connect to the Internet using a telephone line connection, modem 975 is connected to serial port 964 and PCI-to-ISA Bridge 935.

While the computer system described in FIG. 9 is capable of executing the processes described herein, this computer system is simply one example of a computer system. Those skilled in the art will appreciate that many other computer system designs are capable of performing the processes described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method for text conversion using a computer system, said method comprising:
receiving a text block from a text file;
performing semantic analysis on the text block;
selecting one or more voice attributes based upon the semantic analysis result; and
converting the text block to audio using the selected voice attributes.

2. The method as described in claim 1 wherein at least one of the voice attributes is selected from the group consisting of a pitch value, a loudness value, and a pace value.

3. The method as described in claim 1 wherein the converting further comprises:
providing the selected voice attributes to a voice synthesizer; and
performing the converting using the voice synthesizer.

4. The method as described in claim 3 wherein the providing is performed using an API.

5. The method as described in claim 1 wherein the text file is received from a server, and wherein the server performs the semantic analysis.

6. The method as described in claim 5 wherein the server is adapted to include one or more semantic tags with the text block, the semantic tags corresponding to the semantic analysis result.

7. The method as described in claim 6 further comprising:
extracting one of the semantic tags from the text block;
executing latent semantic indexing on the semantic tag; and
performing the selecting using the results of the latent semantic indexing.

8. The method as described in claim 1 further comprising:
receiving the text file;
identifying one or more section breaks in the text file; and
dividing the text file into a plurality of text blocks using the identified section breaks.

9. The method as described in claim 1 further comprising:
identifying a semantic identifier from a plurality of semantic identifiers in response to the semantic analysis; and
using the semantic identifier to perform the voice attributes selection.

10. The method as described in claim 9 further comprising:
determining whether one or more user interest semantic identifiers are selected; and
wherein the plurality of semantic identifiers includes one or more of the user interest semantic identifiers based upon the determination.

11. The method as described in claim 10 wherein the user interest semantic identifiers are selected from the group consisting of a summary, a detail, a conclusion, and a section heading.

12. The method as described in claim 1 wherein the plurality of semantic identifiers include subject matter semantic identifiers, and wherein at least one of the subject matter semantic identifiers is selected from the group consisting of a children's book, a business journal, a male related, a female related, and a teenager related.

13. The method as described in claim 1 wherein the text file is retrieved from a file location, and wherein the file location is selected from the group consisting of a web page server, a computer hard drive, a compact disc, a floppy disc, and a digital video disc.

14. An information handling system comprising:
one or more processors;
a memory accessible by the processors;
one or more nonvolatile storage devices accessible by the processors; and
a text conversion tool to convert text to audio, the text conversion tool comprising software code effective to:
receive a text block from a text file;
perform semantic analysis on the text block;
select one or more voice attributes based upon the semantic analysis result from one of the nonvolatile storage devices; and
convert the text block to speech using the selected voice attributes.

15. The information handling system as described in claim 14 wherein at least one of the voice attributes is selected from the group consisting of a pitch value, a loudness value, and a pace value.

16. The information handling system as described in claim 14 wherein the software code is further effective to:
provide the selected voice attributes to a voice synthesizer; and
use the voice synthesizer to perform the text block conversion.

17. The information handling system as described in claim 16 wherein the voice attributes are provided using an API.

18. The information handling system as described in claim 14 wherein the text file is received from a server, and wherein the server performs the semantic analysis.

19. The information handling system as described in claim 18 wherein the server is adapted to include one or more semantic tags with the text block, the semantic tags corresponding to the semantic analysis result.

20. The information handling system as described in claim 19 wherein the software code is further effective to:
extract one of the semantic tags from the text block;
execute latent semantic indexing on the semantic tag; and
perform the voice attributes selection using the results of the latent semantic indexing.

21. The information handling system as described in claim 14 wherein the software code is further effective to:
receive the text file;
identify one or more section breaks in the text file; and
divide the text file into a plurality of text blocks using the identified section breaks.

22. The information handling system as described in claim 14 wherein the software code is further effective to:
identify a semantic identifier from a plurality of semantic identifiers in response to the semantic analysis; and
use the semantic identifier to perform the voice attributes selection.

23. The information handling system as described in claim 22 wherein the software code is further effective to:
determine whether one or more user interest semantic identifiers are selected; and
wherein the plurality of semantic identifiers includes one or more of the user interest semantic identifiers based upon the determination.

24. The information handling system as described in claim 23 wherein the user interest semantic identifiers are selected from the group consisting of a summary, a detail, a conclusion, and a section heading.

25. The information handling system as described in claim 14 wherein the plurality of semantic identifiers include subject matter semantic identifiers, and wherein at least one of the subject matter semantic identifiers is selected from the group consisting of a children's book, a business journal, a male related, a female related, and a teenager related.

26. The information handling system as described in claim 14 wherein the text file is retrieved from a file location, and wherein the file location is selected from the group consisting of a web page server, a computer hard drive, a compact disc, a floppy disc, and a digital video disc.

27. A computer program product stored on a computer operable media for converting text to audio, said computer program product comprising:
means for receiving a text block from a text file;
means for performing semantic analysis on the text block;
means for selecting one or more voice attributes based upon the semantic analysis result; and
means for converting the text block to audio using the selected voice attributes.

28. The computer program product as described in claim 27 wherein at least one of the voice attributes is selected from the group consisting of a pitch value, a loudness value, and a pace value.

29. The computer program product as described in claim 27 wherein the converting further comprises:
means for providing the selected voice attributes to a voice synthesizer; and
means for performing the converting using the voice synthesizer.

30. The computer program product as described in claim 29 wherein the providing is performed using an API.

31. The computer program product as described in claim 27 wherein the text file is received from a server, and wherein the server performs the semantic analysis.

32. The computer program product as described in claim 31 wherein the server is adapted to include one or more semantic tags with the text block, the semantic tags corresponding to the semantic analysis result.

33. The computer program product as described in claim 32 further comprising:
means for extracting one of the semantic tags from the text block;
means for executing latent semantic indexing on the semantic tag; and
means for performing the selecting using the result of the latent semantic indexing.

34. The computer program product as described in claim 27 further comprising:
means for receiving the text file;
means for identifying one or more section breaks in the text file; and
means for dividing the text file into a plurality of text blocks using the identified section breaks.

35. The computer program product as described in claim 27 further comprising:
means for identifying a semantic identifier from a plurality of semantic identifiers in response to the semantic analysis; and
means for using the semantic identifier to perform the voice attributes selection.

36. The computer program product as described in claim 35 further comprising:
means for determining whether one or more user interest semantic identifiers are selected; and
wherein the plurality of semantic identifiers includes one or more of the user interest semantic identifiers based upon the determination.

37. The computer program product as described in claim 36 wherein the user interest semantic identifiers are selected from the group consisting of a summary, a detail, a conclusion, and a section heading.

38. The computer program product as described in claim 27 wherein the plurality of semantic identifiers include subject matter semantic identifiers, and wherein at least one of the subject matter semantic identifiers is selected from the group consisting of a children's book, a business journal, a male related, a female related, and a teenager related.

39. The computer program product as described in claim 27 wherein the text file is retrieved from a file location, and wherein the file location is selected from the group consisting of a web page server, a computer hard drive, a compact disc, a floppy disc, and a digital video disc.
